(19) United States
(12) Patent Application Publication
(10) Pub. No.: US 2003/0161154 A1
(43) Pub. Date: Aug. 28, 2003

(54) Free mapping colored illuminator and a luminaire of said illuminator

(76) Inventors: Chieh Ouyang, Xiamen City (CN); Wei Ouyang, Xiamen City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 10/082,322

(22) Filed: Feb. 26, 2002

(51) Int. Cl. F21V 23/00

(52) U.S. Cl. 362/295; 362/800; 362/226

(57) ABSTRACT

The present invention provides a free mapping colored illuminator and a luminaire made of said illuminator, said free mapping colored illuminator is comprised of a shade, a light-emitting diode and a control, wherein said light-emitting diode has a concentric anode and three negative cupules for placing three colored light-emitting wafers (red, green and blue) separately connecting to said anode, and said control has an IC circuit built on the inside for controlling mapping variety colors. Said light-emitting wafer can be selected between in bulb-type and in pellet-type. By changing the duty cycle of said diode, the color emitted by the light source can be changed at will, in accordance with mixing different colors to generate variety colored effects, and three different colors just as red, blue and green emitted from said three light-emitting diodes can compound variety colored light. The present invention can be utilized as combining large-scale open-air advertising board, neon, road and bridge guide lamp, electric displaying screen and so on distant luminaries. The feather of the present invention is small volume, low dissipation and high reliability, and long service life.

### BACKGROUND OF THE INVENTION

1. Field of the Invention

The present invention relates to an illuminator, and more particularly to a free mapping colored illuminator and a luminaire made of said illuminator.

2. Description of Prior Art

In accordance with the conventional illuminator adopting light-emitting diodes as a light source so far, a free changeable colored solid-illuminator, declared itself in the Chinese patent No.: CN1047691C coordinating to the patent No.: 94112278.6, makes use of an industrial plastic molded tube base with a parabolic reflector at inside, and a hemispheroid concave set upon the focus of said parabolic reflector at the top side of said tube base downwardly, and three red, green and blue primary color LED light-emitting wafers located on the inside of said concave connected their anodes together with a wire, then all of them concreted on said parabolic reflector by casting transparent epoxy resin to form solid illuminator with two-fold reflecting. On the other hand, by adjusting the current of every light-emitting diode, the colors of said light source could be changed freely. A light-emitting array combined by a certain number of said individual solid illuminator is used as an indicator or a full-color displayer. Due to said light-emitting wafers located on the inside of said concave, the heat generated by conducting current for a long term is not cooled in this construction easily so that the service life of said light-emitting wafers will be shortened. Additionally, by changing the current of LED to change the color of said light source, the available colors are not enough as desire, and said two-fold reflecting construction for improving intensive of light is complex.

### OBJECTS AND SUMMARY OF THE INVENTION

It is therefore a main object of the present invention to provide a mapping colored illuminator with LED as luminescent source that can change the color of emitted light freely, and be simple construction in convenient for installation, and be long service life, and a decorating luminaire made of said illuminator.

This object is achieved by a mapping colored illuminator, which is comprised of a shade, light-emitting diodes and a control, wherein said light-emitting diode is composed of three light-emitting wafers in tricolor—red, green and blue with a concentric anode, said tricolor light-emitting wafers are placed on three negative cupules separately connecting with said concentric anode, and said control includes an IC circuit supplying many variant composite color output in duty cycle.

Said light-emitting diode is bulb-type, there are four parallel metal trestles located in the inside of a snoot working as a shade, and leading out four pins from the bottom side, therein one pin is said concentric anode of LED, and the three rest are negative poles. There are three conducting cupules located on the top ends of said three negative metal trestles separately for placing said tricolor light-emitting wafers; wherein, said red light-emitting wafer is placed vertically just like P-pole at upper and N-pole at bottom connecting to said conducting metal cupule via conducting paste in position; the other two colored light-emitting wafers are placed in level, the N-poles of them are connected to said negative poles through metal wires, and the P-poles of said all wafers are led to said concentric anode by metal wires.

Said light-emitting diode is pellet-type diode, in which the base pins are arranged on the circumference of a pedestal, within three are negative poles, and three different colored light-emitting wafers are located in a central recess of said pedestal, therein the red light-emitting wafer is placed vertically just like P-pole at upper and the N-pole at bottom connecting to said central recess via conducting paste; the other two colored light-emitting wafers are placed in level, the N-poles are connected to said negative poles through metal wires separately; the P-pole of every wafer is led to said concentric anode by metal wires separately.

Said IC circuit is attached an acoustic or cell-phone control triggering-circuit in connection.

Said shade is made of frosted glass.

Said the composite duty cycle includes color fading out, color flashing and graduating color cycle.

Said color fading-out follows following sequence: white, red, orange, yellow, green, blue, indigo and violet.

A mapping colored illuminator is comprised of a shade, light-emitting diodes and a control, wherein said light-emitting diode is composed of three light-emitting wafers in tricolor—red, green and blue with a concentric anode, said tricolor light-emitting wafers are placed on three negative cupules separately connecting with said concentric anode, and said control includes an IC circuit supplying many variant composite color output in duty cycle, which is comprised of an IC component and a PC board, wherein said IC component is set upon the up surface of said PC board, said light-emitting diodes are triangle-arranged on the surface of said PC board; and said illuminator is led out with three pins: one is anode, one is negative, and the rest is control pin.

Said control pin has a curved projection.

Said IC component is set upon the bottom side of said PC board.

A decorating luminaire made of said light-emitting diodes has a pattern figure composed of many light-emitting diodes arranged in connection, and the way of lighting is controlled by said IC circuit, wherein said light-emitting diode is composed of three light-emitting wafers in tricolor—red, green and blue with a concentric anode, said tricolor light-emitting wafers are placed on three negative cupules separately connecting with said concentric anode, and said control includes an IC circuit supplying many variant composite color output in duty cycle.

The patterns of lighting of above-mentioned luminaire include full flashing, full lighting, pursuing, running, fading in or out, colored flashing, color changing, intensity switching, part lightening and segment lightening.

Following profitable effects can be archived:

1. By changing the duty cycle of said diode, the color emitted by the light source can be changed at will, in accordance with mixing different colors to generate variety colored effects, and three different colors just as red, blue and green emitted from said three light-emitting diodes can compound variety colored light. And the intensity of every said light can be adjusted by the advantage of the IC of said control so as to come into being creating changeable variety colors of emitted light with graduating changed colors to generate beautiful visual effect.

2. Said three light-emitting wafers are separately placed in different cupules in the present invention so that the cool effect is improved.

3. The light source has enough intensity to adopt direct shoot in the present invention without paraboloid and reflector, so that it not only simplifies the construction, but also the light-emitting wafer can be selected between bulb-type and pellet-type.

4. The present invention can be used for various decorating luminaries for meeting different purposes. Combining the LED under a transparent shade in a certain array, in which the color and the intensity of the light are controlled by said IC circuit, can be applied in large-scale open-air advertising board, neon, road and bridge guide lamp, electric displaying screen and so on. For the near light-source luminaries, said frosted glass shade can scatter the light to obtain well-mixing the three colors to show variety colored light, the feather of the present invention is small volume, low dissipation and high reliability, and long service life.

### BRIEF DESCRIPTION OF THE DRAWINGS

FIG. 1 is a scheme showing the bulb-type light-emitting diode of the present invention.

FIG. 2 is a scheme showing the structure of the bulb-type light-emitting diode of the present invention.

FIG. 3 is a scheme showing the structure of the pellet-type light-emitting diode of the present invention.

FIG. 4 is a connecting diagram of the IC circuit of the present invention.

FIG. 5 is a flowchart of changing color of present invention.

FIG. 6 is a connecting diagram of the IC circuit attached with a cell-phone triggering-circuit of the present invention.

FIG. 7 is a solid view showing another embodiment of the present invention.

FIG. 8 is a right-side view of FIG. 7.

FIG. 9 is a main side view showing the illuminator located on the up surface of the PC board of FIG. 7 of the present invention.

FIG. 10 is a solid view showing the third embodiment of the present invention.

FIG. 11 is a right-side view of FIG. 10.

FIG. 12 is a main-side view showing the illuminator located on the up surface of the PC board in the third embodiment of FIG. 10 of the present invention.

FIG. 13 is a main-side view showing the illuminator located on the bottom surface of the PC board in the third embodiment of FIG. 10 of the present invention.

FIG. 14 is a solid view showing a flash lamp application of the present invention.

FIG. 15 is an exploded view of the flash lamp of the present invention.

FIG. 16 is an exploded view showing the flash lamp core component of the present invention.

FIG. 17 is a solid view showing the flash lamp core component of the present invention.

FIG. 18 is a scheme showing the position relationship of the internal components of the flash lamp of the present invention.

### DETAILED DESCRIPTION OF PREFERRED EMBODIMENTS

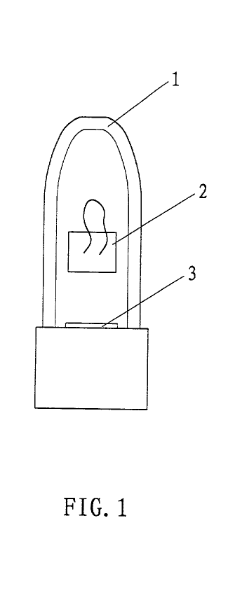

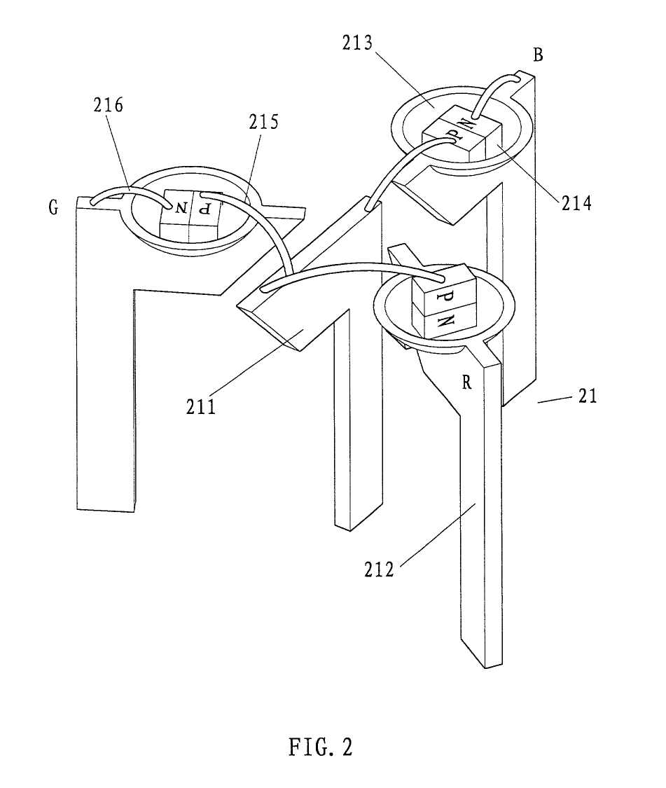

Referring to FIG. 1 and FIG. 2, an illuminator is comprised of a shade 1, a light-emitting diode 2 and a control 3, wherein said light-emitting diode 2 is a bulb-type diode 21, said shade 1 contains four parallel metal trestles at inside and leading out four pins out from the bottom side, therein one pin is the anode 211 of said bulb-type light-emitting diode 21, and the three rests are the negative poles 212. There is a metal conducting cupule 213 located on the top end of every said negative pole for placing one of three said tricolor light-emitting wafer 214, wherein said three light-emitting wafers 214, red, green and blue, are arranged in triangle arrangement, and the P-poles of the three light-emitting wafers are led to the anode 211 by the wires 215 separately, and three wires 215 connect the three N-poles to each negative poles 212 separately, in which the red light-emitting wafer stands on the N-pole as a based side vertically, just like the P-pole at upper and the N-pole at bottom connecting to the metal cupule 213 with conducting paste; on the other hand, the other rests are placed in level, therein the N-poles are connected to the negative poles 212 by the wires 216 separately. Under the control of IC circuit, by changing the duty cycle of said light-emitting diode, mapping color function can be brought into being.

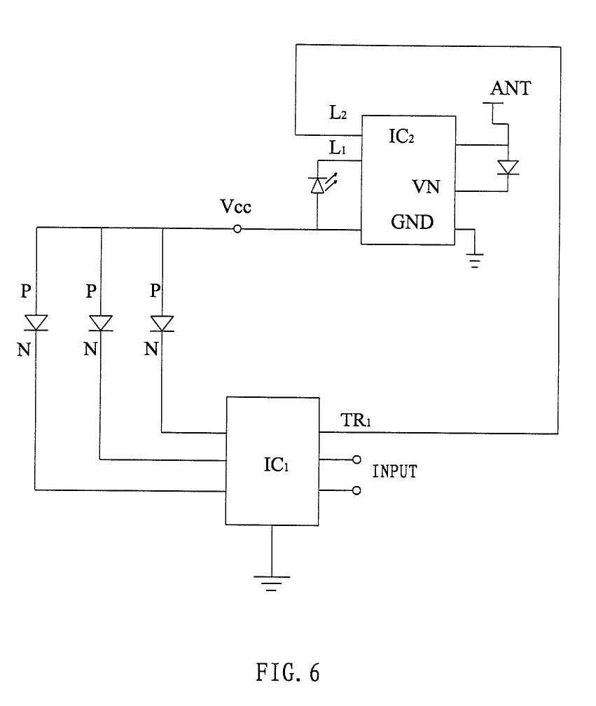

As shown in FIG. 6, the method of mapping color of said illuminator, composed of three LED, is divided into 5 steps as following:

1. Said red, green and blue three LED are getting to light up and light off under the control to carry out full-colored 256 colors mapping in graduating cycle such as white, red, orange, yellow, green, blue, purple, violet.

2. Stopping on the colored light.

3. Flashing the colored light of Step 2.

4. Flashing the colored light randomly in said seven colors and white.

5. Ending.

The method of mapping colors is not limited in above-mentioned, by changing the duty cycle of said diode, obtain high speed of mapping color, and make said tricolor light-emitting diodes mix the colors to compound about 4,096 colors. The light-emitting style can be selected in graduating changing, color flashing or circulating.

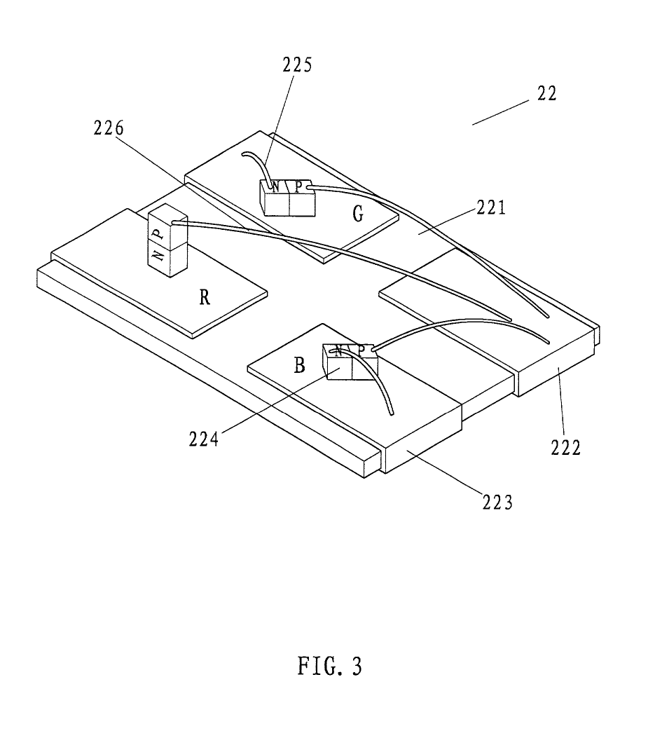

As shown in FIG. 3, an illuminator is comprised of a shade 1, a light-emitting diode 2 and a control 3, wherein said light-emitting diode 2 is a pellet-type diode 22, in which the base pins leading out are arranged on the circumference of a pedestal, within one is the anode 222, three are negative poles. And three different colored light-emitting wafers (red, green and blue) 224 are located in a central recess 223 of said pedestal, therein the red light-emitting wafer is placed vertically just like P-pole at upper and the N-pole at bottom connecting to said central recess via conducting paste; the other two colored light-emitting wafers are placed in level, the N-poles are connected to said negative poles 223 through metal wires 225 separately; the P-pole of every wafer is led to said concentric anode 222 by metal wires 226 separately; Under the control of IC circuit, by changing the duty cycle of said light-emitting diode, mapping color function can be brought into being.

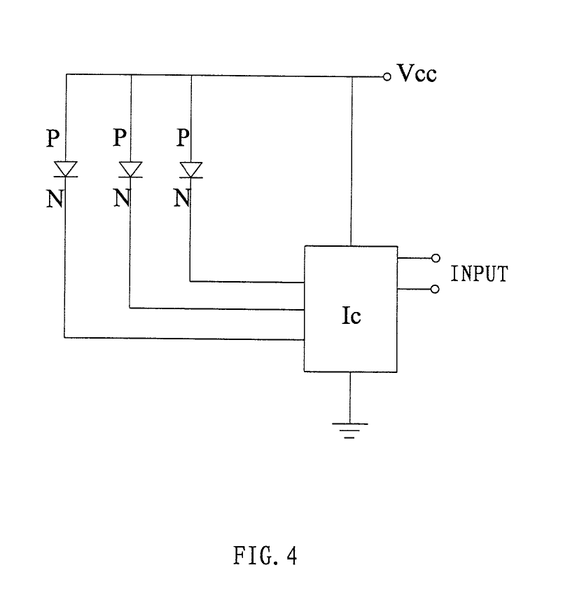

Above-mentioned illuminators can be utilized as combining large-scale open-air advertising board, neon, road and bridge guide lamp, electric displaying screen and so on distant luminaries in different arrangement, by the control of the IC circuit to change the colors and the brightness. Said IC circuit, as shown in FIG. 4, can be connected with an acoustic control triggering-circuit so that giving out a sound just like clapping one's hands can trigger to the next step of mapping color cycle. And said IC circuit can be also attached with a cell-phone control triggering-circuit in connection. The TR1 pin of said IC is connected to the flashing signal of a light-emitting diode indicating call coming in as a triggering signal. As shown in FIG. 6, in the circuit, IC1 is the full-color control IC; IC2 is the IC controlling the flashing as a call coming in, and a shunt diode crossly connects the IC2 to the antenna ANT receiving signals.

Another illuminator applying in close decorating, is comprised of a shade 1, a light-emitting diode 2 and an IC control circuit 3. Wherein said shade is made of frosted glass for well mixing colors and scattering light.

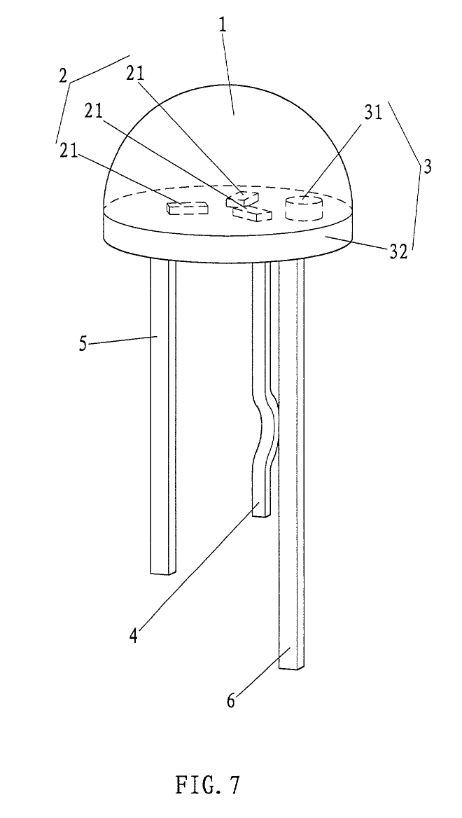

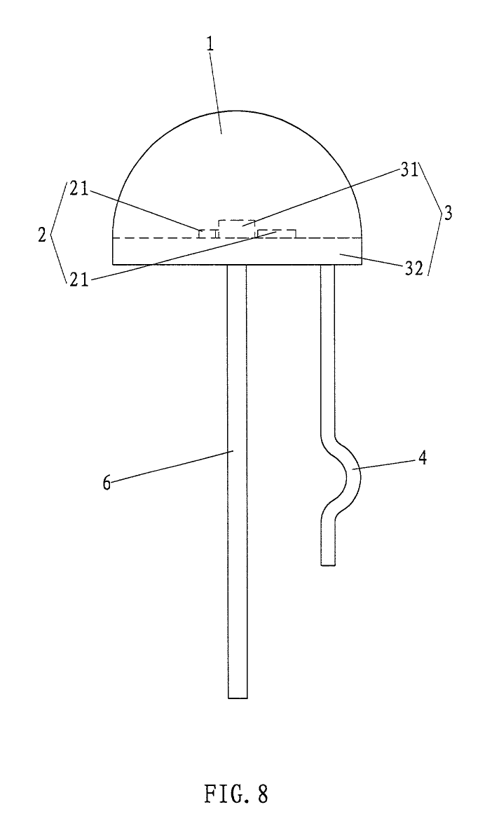

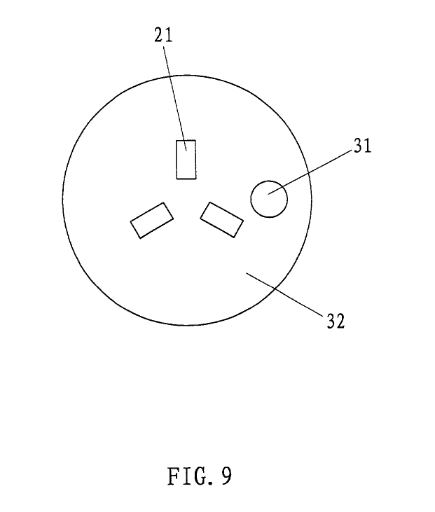

Referring to FIG. 7 to FIG. 9, a free mapping colored illuminator is comprised of a shade 1, a light-emitting diode 2 and a control 3, wherein said light-emitting diode 2 is designed as same structure as above-mentioned in above embodiment (as shown in FIG. 2 and FIG. 3). Said control—IC circuit 3 is comprised of an IC component 31 and a PC board 32 located with said IC component 31 on the up surface, said IC circuit is preset three trigger controls—just like touching trigger, acoustic trigger and cell-phone trigger. Said light-emitting diodes 2 are arranged in triangle array on said PC board 32. Said illuminator is led out three terminals from the bottom including two power pins 4 and 5, and a control pin 6, among of them, said power pin 4 has a curved projection 41, and said control pin 6 is used as a triggering pin of said IC circuit led out from said control.

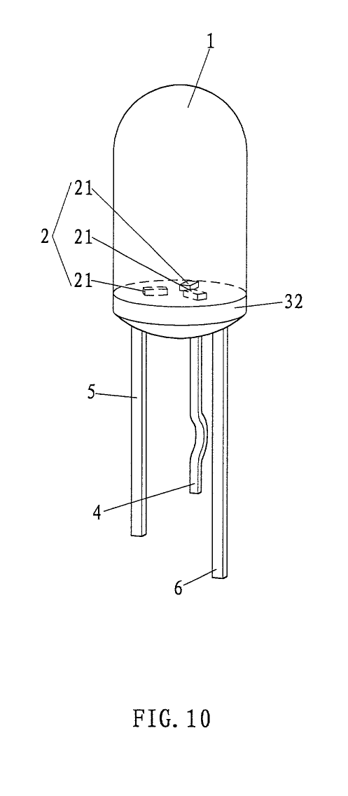

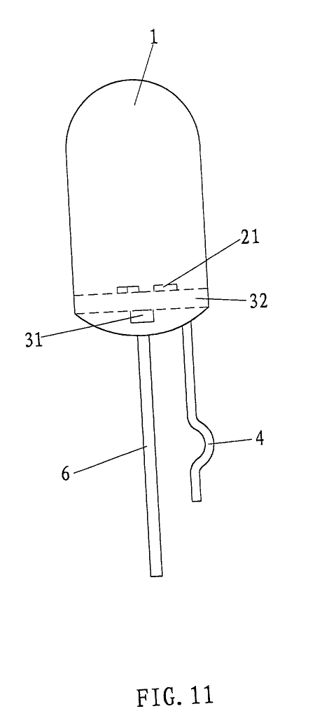

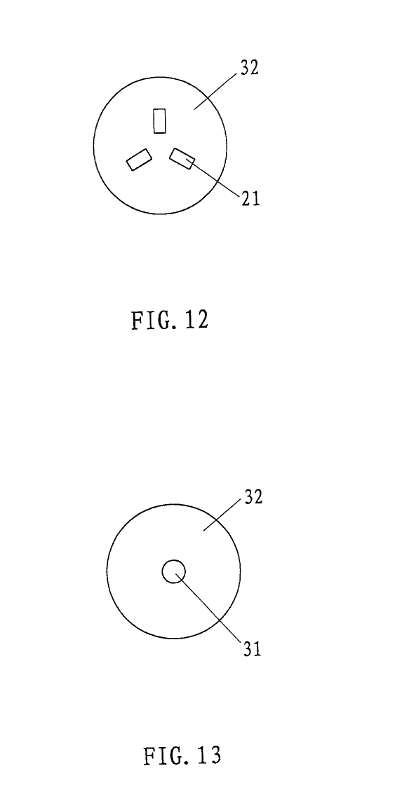

As shown in FIG. 10 to FIG. 13, a free mapping colored illuminator is comprised of a shade 1, a light-emitting diode 2 and a control 3, wherein said light-emitting diode can be in the structure as shown in FIG. 2 and FIG. 3. Said IC circuit 3 is comprised of an IC component 31 and a PC board 32 located with said IC component 31 on the bottom surface, said light-emitting diodes 2 are arranged in triangle array on said PC board 32; said illuminator is led out three terminals including two power pins 4 and 5, and a control pin 6, among of them, said power pin 4 appeals into curved projection 41.

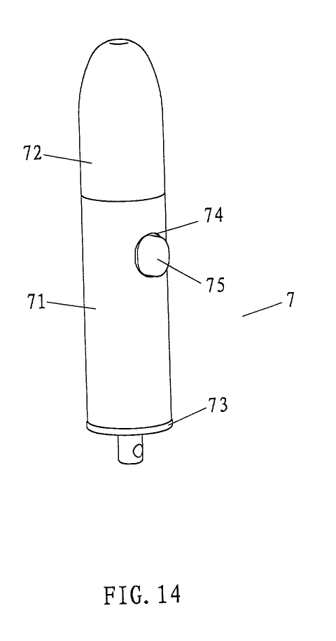

A pocket flash lamp 7 shown in FIG. 14 is used for illustrating the working way of said three terminals led out from said illuminator (shown in FIG. 7 and FIG. 10).

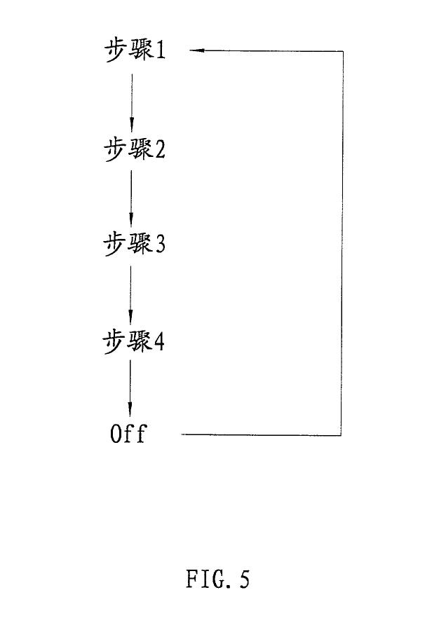

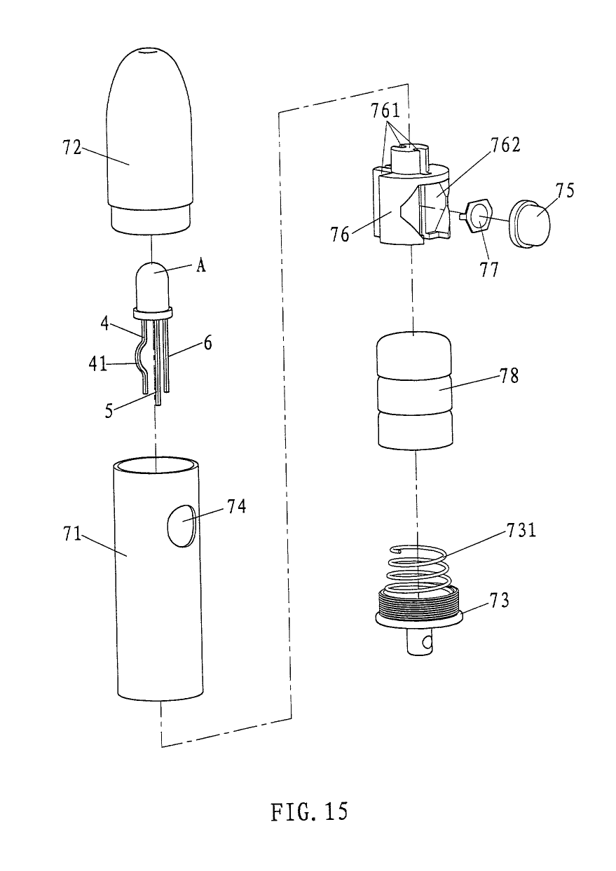

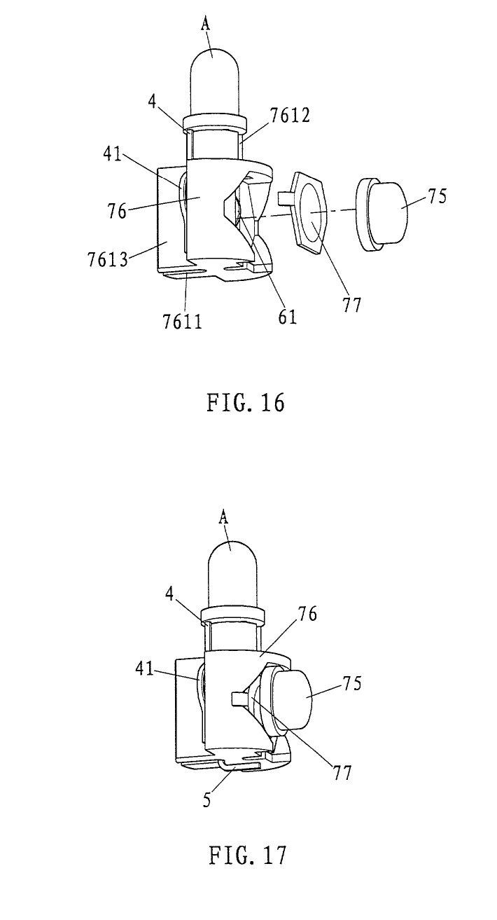

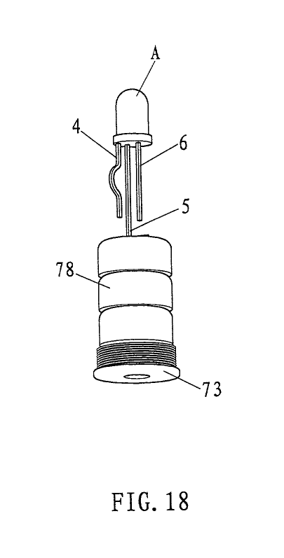

Referring to FIG. 15 to FIG. 17, said flash lamp 7 includes a hollow copper tube 71 connecting to a transmission mantle 72 with one end in sleeve joint, and a back cap 73 secured on another end; there is a hole built on the side wall for locating a button 75. Wherein, said sleeve 71 is attached with a core component 76 made of electrical insulating material, on which three disconnected guide slots 761, including 7611 7612 and 7613, for plugging the three pins of said illuminator A in so that said illuminator A is just plugged on the seat—the plastic core component 76 at all, wherein said power pin 4 is set as anode pin coordinating to the slot 7613 it is plugged in but the curved projection 41 is exposed in the opening side; the negative pin 5 is stretched out from the bottom side of said core component 76 throughout said guide slot 7611, and is bent up for touching against the cell battery 78 set on the bottom, as shown in FIG. 18; said control pin 6 passes through the guide slot 7612, and is exposed a middle segment in a groove 762 built on the proper position and covered a triangle elastic leaf 77; and said control pin 6 is crowned by the guide slot 7612 to form a crown coordinating to the button 75. In combination, said transmission mantle 72 is firstly mounted on said sleeve 71, then said core component 76, the triangle elastic leaf 77, the button 75 and the dry cell battery set 78 are installed into the inside of the sleeve 71 sequentially, finally screw up the back cap 73, which holds a spreader spring 731 welded on the inside and has an internal thread built on for securing on the back end of said sleeve 71. The curved projection 41 of said anode pin 4 touches against the inside wall of said metal sleeve 71, and is kept to contact with negative pin 5 in connection state always. In using, press down the button 75 to push the triangle elastic leaf 77 to contact with the control pin 6 of said illuminator A to trigger the IC circuit 3 to drive the illuminator A following a preset duty cycle to lighten. Said patterns of lightening is shown in FIG. 5, by pressing down the button 75 in one time is meant to carry out one step, for example, pressing down the button 75 in the first time is to carry out the step 1, by pressing again as the second time is means to carry out step 2, and so on and so forth. If not using the button 75, using sound or cell-phone to trigger the control the pattern of lightening.

Above-mentioned free mapping colored illuminator of the present invention also can be used in a decorating luminaire, wherein many light-emitting diodes are arranged into the inside of said shade following a desired pattern figure in connection, and controlled by said IC circuit to give out light in one of presetting composite patterns. Therein, said light-emitting diode is composed of three light-emitting wafers in tricolor—red, green and blue with a concentric anode, said tricolor light-emitting wafers are placed on three negative cupules separately connecting with said concentric anode. Said control of said luminaire includes an IC circuit supplying many variant composite color output in duty cycle. The patterns of lightening of above-mentioned luminaire include full flashing, full lighting, pursuing, running, fading in or out, colored flashing, color changing, intensity switching, part lightening and segment lightening.

I claim:

1. A free mapping colored illuminator comprised of a shade, a light-emitting diode and a control, wherein said light-emitting diode has a concentric anode and three negative cupules for placing three colored light-emitting wafers (red, green and blue) separately connecting to said anode, and said control has an IC circuit built on the inside for controlling mapping variety colors.

2. A free mapping colored illuminator as claimed in claim 1, wherein said light-emitting diode is in bulb-type, there are four parallel metal trestles located in the inside of a snoot as a shade, and leading out four pins from the bottom side, therein one pin is said concentric anode of LED, and the three rest are negative poles; there are three conducting cupules located on the top ends of said three negative metal trestles separately for placing said tricolor light-emitting wafers; wherein, said red light-emitting wafer is placed vertically just like P-pole at upper and N-pole at bottom connecting to said conducting metal cupule via conducting paste in position; the other two colored light-emitting wafers are placed in level, the N-poles of them are connected to said negative poles through metal wires separately, and the P-poles of said all wafers are led to said concentric anode by metal wires.

3. A free mapping colored illuminator as claimed in claim 1, wherein said light-emitting diode is in pellet-type, in which the base pins are arranged on the circumference of a pedestal, within three are negative poles, and three different colored light-emitting wafers are located in a central recess of said pedestal, therein the red light-emitting wafer is placed vertically just like P-pole at upper and the N-pole at bottom connecting to said central recess via conducting paste; the other two colored light-emitting wafers are placed in level, the N-poles are connected to said negative poles through metal wires separately; the P-pole of every wafer is led to said concentric anode by metal wires separately.

4. A free mapping colored illuminator as claimed in claim 1, wherein said IC circuit is attached an acoustic or cell-phone control triggering-circuit in connection.

5. A free mapping colored illuminator as claimed in claim 1, wherein said shade is made of frosted glass.

6. A free mapping colored illuminator as claimed in claim 1, wherein said lightening composite pattern includes color fading out, changing colored flashing, and graduating changing color cycle.

7. A free mapping colored illuminator as claimed in claim 1, wherein said color fading-out follows following sequence: white, red, orange, yellow, green, blue, indigo and violet.

8. A free mapping colored illuminator comprised of a shade, a light-emitting diode and a control, wherein said light-emitting diode is composed of three light-emitting wafers in tricolor—red, green and blue with a concentric anode, said tricolor light-emitting wafers are placed on three negative cupules separately connecting with said concentric anode; said control of said luminaire includes an IC circuit supplying many variant composite color output in duty cycle, which is comprised of an IC component and a PC board locating with said IC component on the up surface, said light-emitting diodes are arranged in triangle array on said PC board; said illuminator is led out three terminals including two power pins, and a control pin.

9. A free mapping colored illuminator as claimed in claim 8, wherein one of said power pins has a curved projection.

10. A free mapping colored illuminator as claimed in claim 8, wherein said IC component is located on the bottom surface of said PC board.

11. A luminaire made of said free mapping colored illuminator, wherein a proper number of light-emitting diodes are arranged into the inside of said shade following a desired pattern figure in connection, and controlled by said IC circuit to give out light in one of presetting composite patterns; therein, said light-emitting diode is composed of three light-emitting wafers in tricolor—red, green and blue with a concentric anode, said tricolor light-emitting wafers are placed on three negative cupules separately connecting with said concentric anode, said control of said luminaire includes an IC circuit supplying many variant composite color output in duty cycle.

12. A luminaire made of said free mapping colored illuminator as claimed in claim 11, wherein said patterns of lighting of above-mentioned luminaire include full flashing, full lighting, pursuing, running, fading in or out, colored flashing, color changing, intensity switching, part lightening and segment lightening.
